(19) United States
(12) Patent Application Publication
(10) Pub. No.: US 2024/0140029 A1
(43) Pub. Date: May 2, 2024

(54) APPARATUS AND METHOD FOR THREE-DIMENSIONAL PRINTING

(71) Applicant: SYNCORD 3D TECHNOLOGY LIMITED, SHATIN (HK)

(72) Inventors: Man Fai CHUNG, SHATIN (HK); Tak Yu LAU, SHATIN (HK)

(21) Appl. No.: 18/346,111

(22) Filed: Jun. 30, 2023

(30) Foreign Application Priority Data
Oct. 31, 2022 (HK) 32022062988.7

(51) Int. Cl. B29C 64/209; B29C 64/118; B29C 64/241; B29C 64/245; B29C 64/25; B29C 64/386; B33Y 10/00; B33Y 30/00; B33Y 50/00

(52) U.S. Cl. CPC B29C 64/209; B29C 64/118; B29C 64/241; B29C 64/245; B29C 64/25; B29C 64/386; B33Y 10/00; B33Y 30/00; B33Y 50/00

(57) ABSTRACT

The present application relates to an apparatus and method for three-dimensional printing. The apparatus comprises a gantry, a tilting print head and a rotary table. The tilting print head comprises an extruder, an elongated nozzle connected to the extruder and a filament tube connected to side-entrance of the extruder. The extruder is configured to rotate around the tilting axis. The filament tube is configured to feed the printing material into the extruder. The tilting print head is configured to control the printing material to enter the extruder through the filament tube, spiral through the extruder and enter the elongated nozzle. As the entrance is arranged on the side of the extruder and the filament tube is close to the tilting axis, the printing material can be more stable when the tilting print head rotates upward or downward. The issues of uneven or discontinuous extrusion can be solved

### TECHNICAL FIELD

The present disclosure relates to a field of additive manufacturing, and in particular to an apparatus and method for three-dimensional printing.

### BACKGROUND

Fused Deposition Modeling (FMD) Technology works with three-dimensional printers to build three-dimensional. FDM three-dimensional printing builds three-dimensional model by stacking up layers, which are generated by slicing the Computer Aided Design (CAD) model of different build direction. These layers are subjected to three-dimensional printer to execute the printing accordingly.

In conventional three-dimensional printing, layers are mostly planar, and parallel which are built along a uniform direction. This characteristic creates a number of limitations for the built parts, including: extensive supporting structures are needed for overhanging region (region of layer that is not supported by previous layer), stair-case effect (a surface error due to the planar layered manufacturing) and structural weakness under tensile and shear lading in the build direction (weak layer adhesion).

To resolve or mitigate these issues, one possible way is to vary the build direction or print layers of free-form surfaces instead of planar layers. This kind of three-dimensional printing is often referred to as multi-directional or multi-axis three-dimensional printing and requires new three-dimensional printer/three-dimensional printing apparatus for such fabrication.

Normally, FDM three-dimensional printer mainly comprises only translational axes, namely, X, Y and Z axes, of which X and Y axes' movements are synchronized while Z-axis only varies between transitions of planar layers. Although curved layer printing is possible by synchronized motion of all three axes, the built surface curvature, accuracy and roughness would be limited due to the constant build direction limitation.

### SUMMARY

According to various embodiments of the present disclosure, an apparatus and

method for three-dimensional printing are provided.

An apparatus for three-dimensional printing, comprising:
a gantry, comprising a gantry body and a carriage mounted on the gantry body; the carriage is movable along an X axis, a Y axis and a Z axis of the gantry;
a tilting print head mounted on the carriage, the tilting print head is configured to dispense printing material; the tilting print head is rotatable around a tilting axis; the tilting axis is parallel to the X axis; and
a rotary table configured to hold a printing part, the rotary table is rotatable around a rotation axis; the rotation axis is parallel to the Z axis;
wherein the tilting print head comprises an extruder, an elongated nozzle connected to the extruder and a filament tube connected to side-entrance of the extruder; the extruder is configured to rotate around the tilting axis; the filament tube is configured to feed the printing material into the extruder; the tilting print head is configured to control the printing material to enter the extruder through the filament tube, spiral through the extruder and enter the elongated nozzle.

A method for three-dimensional printing, implemented by an apparatus for three-dimensional printing, the apparatus for three-dimensional printing comprises:
a gantry, comprising a gantry body and a carriage mounted on the gantry body; the carriage is movable along an X axis, a Y axis and a Z axis of the gantry;
a tilting print head mounted on the carriage, the tilting print head is configured to dispense printing material; the tilting print head is rotatable around a tilting axis; the tilting axis is parallel to the X axis; and
a rotary table configured to hold a printing part, the rotary table is rotatable around a rotation axis; the rotation axis is parallel to the Z axis;
the method comprising:
receiving a position instruction, a build orientation instruction and an extrusion rate instruction;
controlling a motion of the gantry based on the position instruction;
controlling a motion of the tilting print head and a motion of the rotary table based on the build orientation instruction; and
controlling the tilting print head to dispense the printing material based on the extrusion rate instruction.

Details of one or more embodiments of the present disclosure will be given in the following description and attached drawings. Other features, objects and advantages of the present disclosure will become apparent from the description, drawings, and claims.

### BRIEF DESCRIPTION OF THE DRAWINGS

In order to better describe and illustrate the embodiments and/or examples of the contents disclosed herein, reference may be made to one or more drawings. Additional details or examples used to describe the drawings should not be considered as limiting the scope of any of the disclosed contents, the currently described embodiments and/or examples, and the best mode of these contents currently understood.

FIG. 1 illustrates a perspective view of an apparatus for three-dimensional printing, according to an embodiment of the present disclosure;

FIG. 2 illustrates a perspective view of a tilting print head of the apparatus shown in FIG. 1;

FIG. 3 illustrates another perspective view of the apparatus shown in FIG. 1;

FIG. 4 illustrates another perspective view of the apparatus shown in FIG. 1;

FIG. 5 illustrates a flowchart for a method for three-dimensional printing implemented by the apparatus shown in FIGS. 1-4, according to an embodiment of the present disclosure;

FIGS. 6-8 illustrate schematic diagrams showing the relation between a build orientation, tilting angle of the tilting print head θ and rotation angle of the rotary table φ;

FIG. 9 illustrates a flowchart for a method for three-dimensional printing implemented by the apparatus shown in FIGS. 1-4, according to another embodiment of the present disclosure;

FIG. 10 illustrates a schematic diagram for a printing model partitioned into different parts with different build direction, according to an embodiment of the present disclosure;

FIG. 11 illustrates a schematic diagram showing printing steps based on the printing model shown in FIG. 10.

### DETAILED DESCRIPTION OF THE EMBODIMENTS

In order to facilitate the understanding of the present disclosure, the present disclosure will be described more fully below with reference to the relevant drawings. Preferred embodiments of the present disclosure are shown in the drawings. However, the present disclosure can be implemented in many different forms and is not limited to the embodiments described herein. On the contrary, the purpose of providing these embodiments is to make the disclosure of the present disclosure more thorough and comprehensive.

Unless otherwise defined, all technical and scientific terms used herein have the same meaning as commonly understood by one of ordinary skill in the art to which this invention belongs. The definitions are provided to aid in describing particular embodiments, and are not intended to limit the claimed invention. The term “and/or” used herein includes any and all combinations of one or more related listed items.

In order to understand this application thoroughly, detailed steps and structures will be provided in the description below to explain the technical solution proposed by this application. Preferred embodiments of this application are described in detail below. However, in addition to these details, there may be other embodiments of this application.

It should be noted that when an element is referred to as being “fixed to” another element, it can be directly on another element or an intervening element may also be present there between. When an element is considered to be “connected to” another element, it can be directly connected to another element or an intervening element may be present at the same time. Terms “inner”, “outer”, “upper”, “lower”, “left”, “right” and similar expressions used herein are for illustrative purposes only, and do not mean that they are the only embodiments.

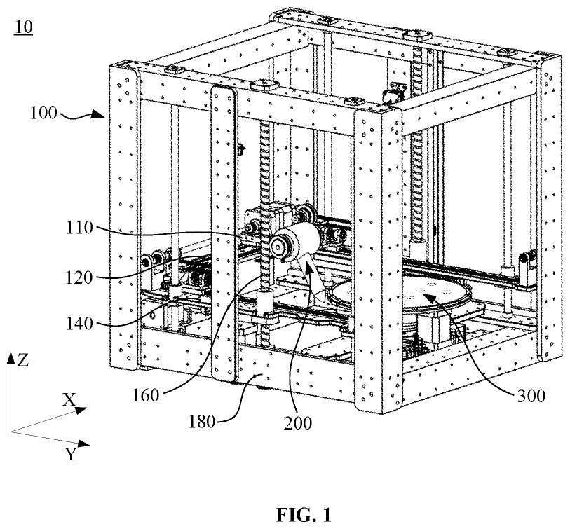

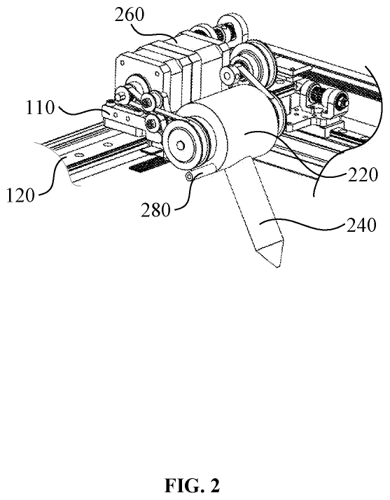

Referring to FIG. 1 and FIG. 2, an apparatus 10 for three-dimensional printing comprises a gantry 100, a tilting print head 200 and a rotary table 300. The gantry 100 comprises a gantry body and a carriage 110 mounted on the gantry body. The carriage 110 is movable along X, Y and Z axes. The tilting print head 200 is mounted on the carriage 110, and the tilting print head 200 is configured to dispense printing material. The tilting print head 200 is rotatable around a tilting axis. The tilting axis is parallel to X axis of the gantry 100. The rotary table 300 is configured to hold printing part, and the rotary table 300 is rotatable around a rotation axis. The rotation axis is parallel to Z axis of the gantry 100.

In order to fabricate freeform surface accurately, the apparatus 10 will have to allow for free manipulation of dispensing direction of the tilting print head 200. For the purpose of being able to theoretically dispense any three-dimensional surface shape without considering collision and support, at least two additional rotary axes need to be incorporated into traditional X-Y-Z gantry configuration and at least 5 axes' movements should be synchronized.

The tilting print head 200 can rotate around a tilting axis. The traditional print head of a three-dimensional printer, such as the print head in Chinese Patent CN111196030A, can't work properly when applied to a rotatable tilting print head 200. The position of the material entrance and the nozzle are generally located at opposite ends of the traditional print head. There are some technical issues in applying a traditional print head to the apparatus 10 for three-dimensional printing. Firstly, as the print head rotates upward or downward, the feed is unstable due to the effect of gravity. The feed instability will lead to uneven or discontinuous extrusion. Sometimes it can even cause elongated feeding nozzle blocked. Secondly, rotating around an axis will pull the printing material, causing the feed to be disturbed. Pulling printing material can also lead to uneven or discontinuous extrusion.

Referring to FIG. 2, the embodiment of the present disclosure provides a solution to the above problems. The tilting print head 200 comprises an extruder 220, an elongated nozzle 240 connected to the extruder 220 and a filament tube 280 connected to a side-entrance of the extruder 220. The extruder 220 is configured to rotate around the tilting axis. The filament tube 280 is configured to feed the printing material into the extruder 220. The tilting print head 200 is configured to control the printing material to enter the extruder 220 through the filament tube 280, spiral through the extruder 220 and enter the elongated nozzle 240.

Instead of arranging the material entrance at the end of print head, the extruder 220 has a side-entrance, and the filament tube 280 connected to the side-entrance. As the entrance is arranged on the side of the extruder 220, not the end of the extruder 220, the effect of gravity would be lessened or weakened when the tilting print head 200 rotates upward or downward. In addition, the filament tube 280 can be close to the tilting axis, which can significantly reduce the magnitude of pulling on the printing. That is to say, as the entrance is arranged on the side of the extruder 220 and the filament tube 280 is close to the tilting axis, the printing material can be more stable when the tilting print head 200 rotates upward or downward. Hence, the issues of uneven or discontinuous extrusion and elongated feeding nozzle blocked can be solved.

In an embodiment, the extruder 220 is in a shape of a circular cylinder, the tilting axis is a cylinder axis of the circular cylinder; the filament tube 280 connected to a base of the circular cylinder. When a cylindrical structure rotates on its cylinder axis, it doesn't interfere with other structures. The cylindrical surface can avoid collision. Further, in an embodiment, the circular cylinder can be a right circular cylinder, so it also doesn't interfere with other structures on the sides. In an embodiment, the filament tube 280 is parallel to the tilting axis, which can more smoothly feed the printing material into the extruder 220.

In the embodiment of the present disclosure, the apparatus 10 includes 5-axis motions for additive manufacturing. Among the 5-axis motions, 3-axis of translational motions are provided by the gantry 100, and 2-axis of rotational motions are provided by the rotary table 300 and the tilting print head 200.

The carriage 110 of the gantry 100 is movable along X, Y and Z axes. The tilting print head 200 is mounted onto the carriage 110 and configured to provide 1-axis of the rotational motion and controlled extrusion. The rotary table 300 is configured to provide another 1-axis of the rotational motion and holds the printing part. The synchronized 5-axis motions and material extrusion build a three-dimensional part.

The apparatus 10 for three-dimensional printing in the above embodiment requires no redundant axis of motion of multi-axis printing (least amount of axes for multi-directional three-dimensional printing). The apparatus 10 is compact, providing large workspace or build space while occupying very limited space. Large workspace implies not only build volume wise, but also build direction (orientation) wise. Specifically, the apparatus 10 not only enables upward and but also downward orientated printing. Unlike traditional rotary-tilting table design, where totally downward oriented printing is impossible. The full motion envelop (span of space of the apparatus 10 for all possible printing position and orientation of the workspace) of the apparatus 10 occupies limited space (unlike robotic solution, 6R robotic arm's envelop occupies huge space) and can be bounded inside a box. The rotational motion provided by the embodiment is separated to a tilting print head 200 and a rotary table 300 which means that there is no serial rotational motion (unlike 6R robotic arm and rotary-tilting table) which provides higher motion stability.

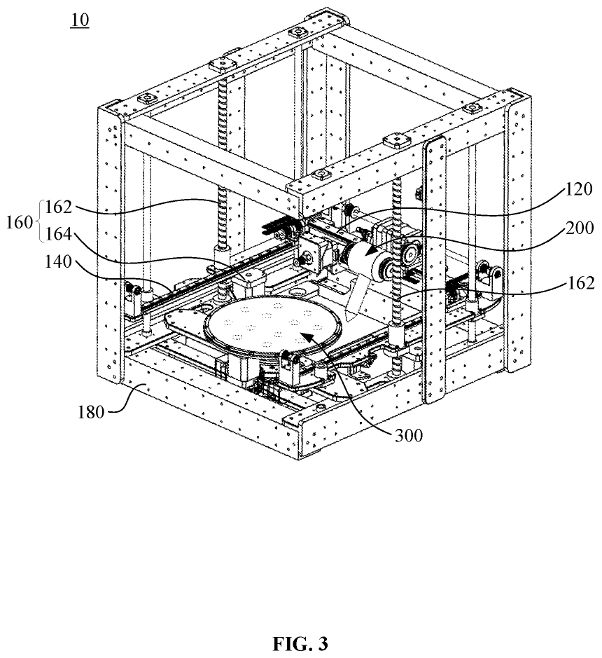

Referring to FIG. 1 and FIG. 3, in some embodiments, the gantry body comprises an X-column 120, a Y-column 140, a Z-column 160 and a base frame 180. The X-column 120 is perpendicular to the Y-column 140, the Y-column 140 is perpendicular to the Z-column 160. The carriage 110 is slidably connected to the X-column 120. The X-column 120 is slidably connected to the Y-column 140. The Y-column 140 is slidably connected to the Z-column 160. The Z-column 160 and the rotary table 300 are fixed on the base frame 180. The gantry 100 comprises 3 columns in combination where each axis column bridges another axis column to connect the translational motion. Further, in this embodiment, the translational motion direction of the carriage 110 along the X-column 120 is horizontal. The translational motion direction of the Y-column 140 along the Z-column 160 is vertical.

In an embodiment, an axis column includes at least one a static member and at least one sliding member. The sliding member can be driven by screw/ball screw or linear motors or belt or chain including. For each axis column, static member like rails and mounts are mounted onto the sliding member like sliders of another axis column perpendicularly to add additional axis of motion. The serial mounting relation between different alignments of axis columns defines the configuration of gantry 100. In the provided embodiments, the vertical Z-column 160 is grounded where a rail is connected to the stationary base frame 180.

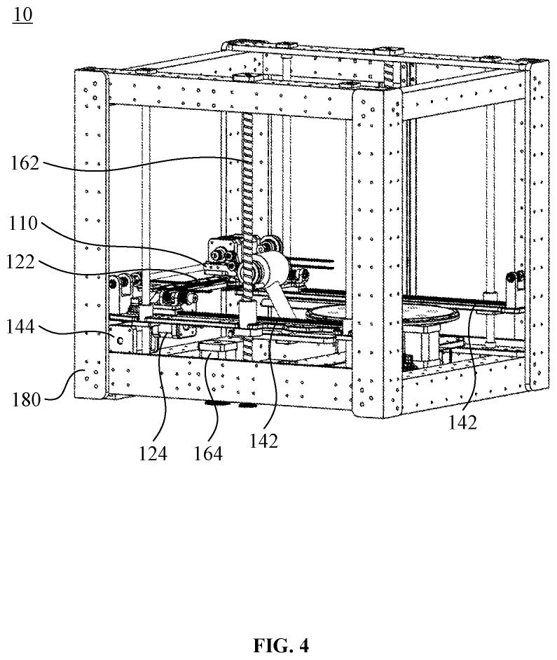

Referring to FIG. 3 and FIG. 4, in an embodiment, the Z-rail of Z-column 160 is mounted onto the base frame. The Z-slider of Z-column 160 is driven vertically by a Z-axis motor 164 and transmitted through a pulley and belt to a ball screw 162. For Y-rail 142 of Y-column 140, it is mounted onto Z-slider to enable its vertical motion. The Y-slider is driven longitudinally by a Y-axis motor 144 and transmitted through a pulley & belt to belt clamp. For X-rail 122 of X-column 120, it is mounted onto Y-slider to enable its longitudinal motion. The X-Slider is driven by an X-axis motor 124 and transmitted through a pulley and belt. Ultimately, the carriage 110 is mounted onto the X-slider to carry the tilting print head 200 to move in translational motion which is controlled by the movement of X, Y & Z axes motors 124, 144, 164.

In some embodiments, referring to FIG. 2, the center-axis of the elongated nozzle 240 is perpendicular to the tilting axis. The tilting motion of the tilting print head 200 enables the elongated nozzle 240 upward and downward orientated printing. The extruder 220 is configured to dispense printing material and rotate around the tilting axis which can be horizontal. The elongated nozzle 240 is provided to extend the distance between the tilting print head 200 and printing part when printing to avoid collision. In the provided embodiments, the tilting print head 200 is directly driven by a tilting motor 260 to control the tilting angle. However, other transmission can be possible alternative.

Further, in one embodiment, the filament tube 280 is configured to feed the printing material into the extruder 220. The printing material is feed into the extruder 220 through the filament tube 280. The filament tube 280 can be roughly parallel to the tilting axis. The printing material, which is normally filament, is configured to enter in side way and spiral through inside to enter the elongated nozzle 240. The extruder 220 to serve printing material feeding purpose may be a screw-driven extruder, a gear-driven extruder, a viscosity pump or a fiber extruder. The placement of such extruder 220 can be a direct setup where it tilts together with the tilting print head 200 or a bowden setup where extruder 220 is placed independent of the motion of tilting motion or a hybrid drive setup where partial of the extruder 220 is placed apart and partial of it tilt with the tilting print head 200. The printing material may be thermoplastic or continuous fiber or composite material.

In some embodiments, the rotary table 300 comprises a magnetic rotary holder and a removable build plate. The build plate is magnetically attached on the rotary holder. The build plate is configured to hold the printing part. The rotary holder can be mounted on the static base frame 180 and configured to provide one axis of motion vertically. The build plate can be magnetically attached on the magnetic rotary holder for the purpose of easy attachment or detachment. The printing part and dispensed material can be hold by the build plate and rotate with the build plate.

In this embodiment, the apparatus 10 for three-dimensional printing can further comprise a controller to control motions of the gantry 100, the tilting print head 200 and the rotary table 300 and extrusion rate of the tilting print head 200. The controller can be built in the apparatus 10. In other embodiments, the controller also can be an external component which can communicate with the apparatus 10. The controller can receive series of commands which represent the build orientation, nozzle position and extrusion rate to control the machine motion to execute such printing path. The controller comprises processing circuitry configured to execute a method for three-dimensional printing.

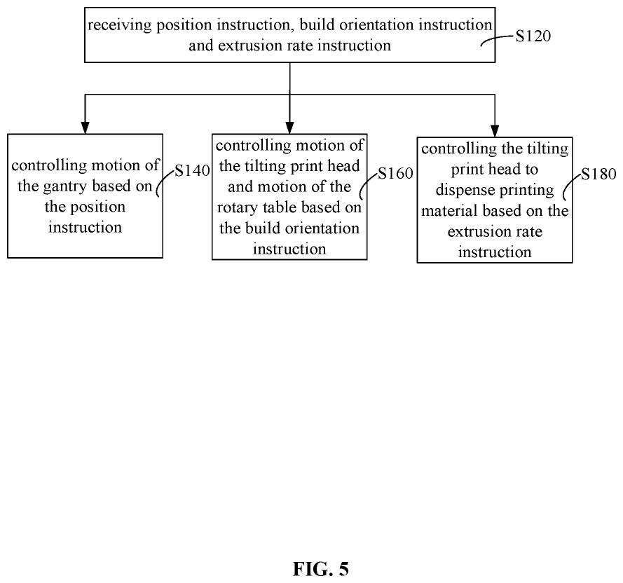

Referring to FIG. 5, the method for three-dimensional printing implemented by the apparatus 10 is also provided. The method comprises the following steps:

S120: receiving a position instruction, a build orientation instruction and an extrusion rate instruction.

S140: controlling a motion of the gantry 100 based on the position instruction.

S160: controlling a motion of the tilting print head 200 and a motion of the rotary table 300 based on the build orientation instruction.

S180: controlling the tilting print head 200 to dispense the printing material based on the extrusion rate instruction.

Steps S140, S160 and S180 can be executed after Step S120. Executions of Steps S140, S160 and S180 are not restricted in sequence. Steps S140, S160 and S180 can be executed synchronously.

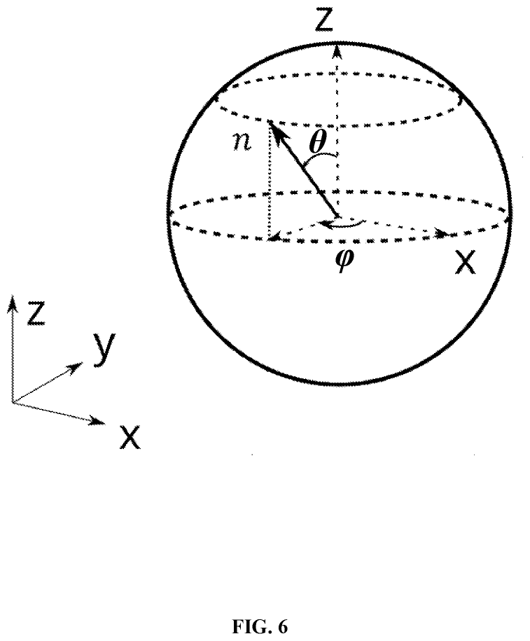

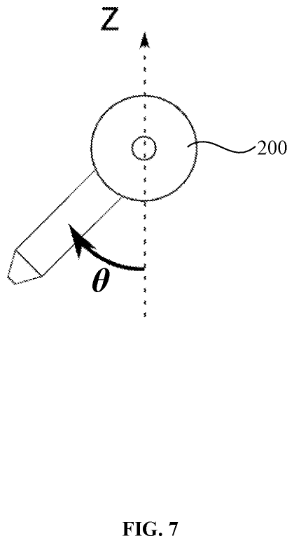

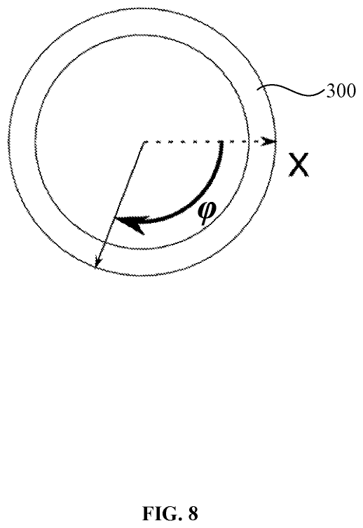

Referring to FIGS. 6-8, in this embodiment, different build orientation is executed through different rotation angle of rotary table 300 and tilting angle of tilting print head 200. The build orientation instruction includes tilting angle of the tilting print head 200 θ and rotation angle of the rotary table 300 φ. Build orientation is represented as a unit vector n=[nₓ n_{y} n_{z}] which is located on a sphere with radius of 1; θ=cos⁻¹(n_{z}), and φ=tan⁻¹(n_{y}/nₓ).

The angle between Z-axis and n is also the tilting angle of the tilting print head 200 θ which can be found by cos⁻¹(n_{z}). The rotation angle of the rotary table 300 φ is the angle between X-axis and the vector projecting onto x-y plane, φ can be found by tan⁻¹(n_{y}/nₓ).

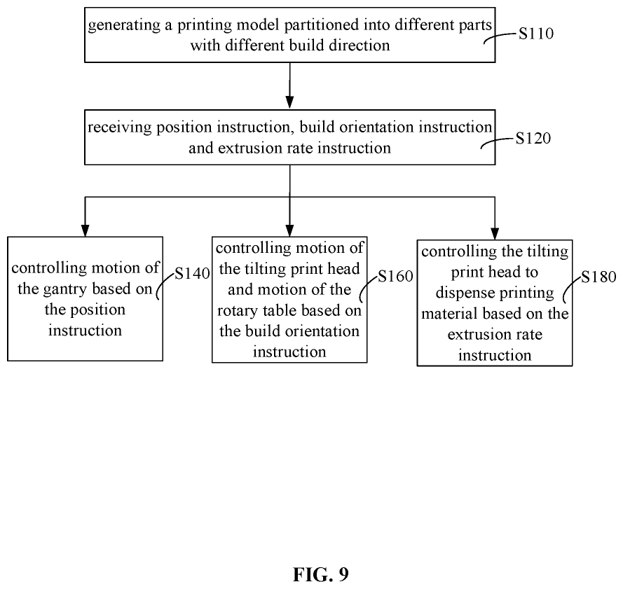

Referring to FIG. 9, in some embodiments, the method can further comprise:

S110, generating a printing model partitioned into different parts with different build direction.

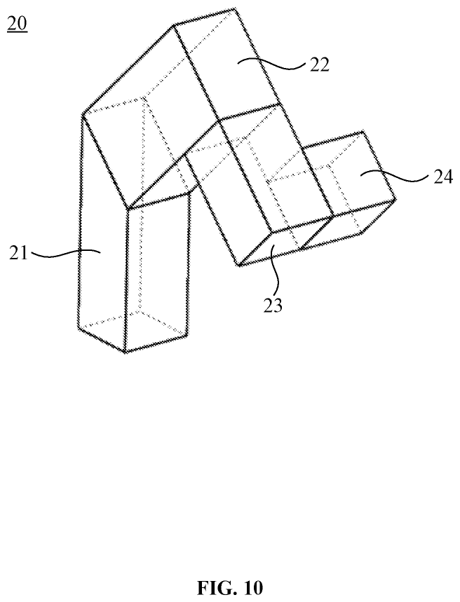

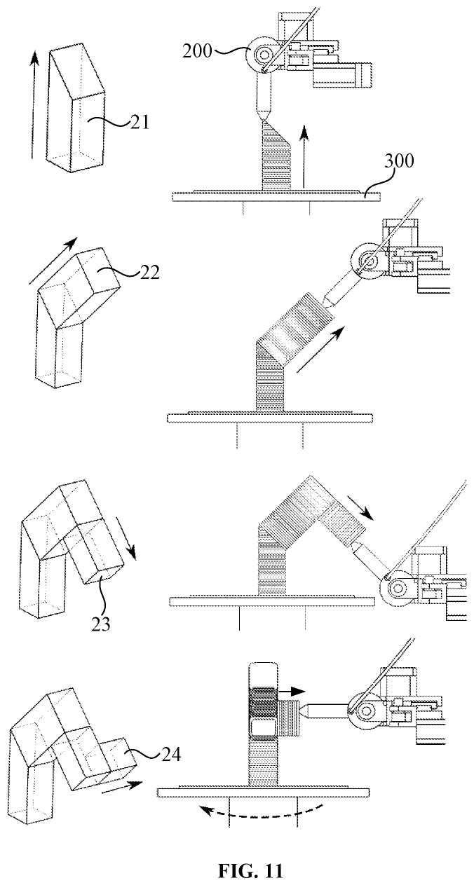

Referring to FIG. 10 and FIG. 11, the print model 20 can be partitioned into different parts with different build direction. In this embodiment, each partition is printed in different build direction layer by layer and executed by the apparatus 10 accordingly. For first partition 21, it is printed vertically along the Z-axis directly on the build plate. Different tilting angle is applied to the print head 200 to print partitions onto the previous print without overhang structure. Not only downward oriented printing like second partition 22 but upward oriented printing like third partition 23 is also possible. In the printing process, rotary table 300 can be controlled to move to print different branch like forth partition 24. In FIG. 11, straight arrows indicate build direction, and the dash curved arrow implies the rotary motion (90deg) from the transition of finishing the third partition 23 to the beginning of the fourth partition 24.

Comparing to normal Robotic Multi-axis Printing solution and Gantry & Rotary-tilting Table solution in multi-axis three-dimensional printing field, the apparatus 10 and method for three-dimensional printing in the embodiments above have advantages in different aspects.

Firstly, Gantry & Rotary-tilting table solution has a serial rotary mechanism which is often heavier and less stable. This solution is impossible to print in downward oriented direction since the tilting column is likely to collide with the print head. This solution also requires both rotation and tilting motion of the printing model which its weight varying in the printing process and can be heavy. Consequently, it requires higher stiffness and heavier rotary-tilting to provide the steady rotation. The tilting motion of the print model induces extra dynamic loading and adding a gravity component that are parallel to the build plate which may increase the possibility of failed print due to failed layer adhesion between the print model and the build plate.

Secondly, Robotic Multi-axis Printing solution occupies huge space. The mechanism of Robotic Multi-axis Printing solution is always complex and expensive. Comparing to Robotic Multi-axis Printing solution, the embodiments of the apparatus 10 and method for three-dimensional printing have better space utilization, less redundant motion with cheaper, lighter and simpler mechanism.

The technical features in the foregoing embodiments may be randomly combined. For concise description, not all possible combinations of the technical features in the embodiment are described. However, provided that combinations of the technical features do not conflict with each other, the combinations of the technical features are considered as falling within the scope recorded in this specification.

The foregoing embodiments only describe several implementations of the disclosure, which are described specifically and in detail, and therefore cannot be construed as a limitation to the patent scope of the disclosure. It should be noted that, a person of ordinary skill in the art may further make variations and improvements without departing from the ideas of the disclosure, which all fall within the protection scope of the disclosure. Therefore, the protection scope of the disclosure is subject to the protection scope of the appended claims.

What is claimed is:

1. An apparatus for three-dimensional printing, comprising:
a gantry, comprising a gantry body and a carriage mounted on the gantry body; the carriage is movable along an X axis, a Y axis and a Z axis of the gantry;
a tilting print head mounted on the carriage, the tilting print head is configured to dispense printing material; the tilting print head is rotatable around a tilting axis; the tilting axis is parallel to the X axis; and
a rotary table configured to hold a printing part, the rotary table is rotatable around a rotation axis; the rotation axis is parallel to the Z axis;
wherein the tilting print head comprises an extruder, an elongated nozzle connected to the extruder and a filament tube connected to side-entrance of the extruder; the extruder is configured to rotate around the tilting axis; the filament tube is configured to feed the printing material into the extruder; the tilting print head is configured to control the printing material to enter the extruder through the filament tube, spiral through the extruder and enter the elongated nozzle.

2. The apparatus for three-dimensional printing of claim 1, wherein the extruder is in a shape of a circular cylinder, the tilting axis is a cylinder axis of the circular cylinder; the filament tube connected to a base of the circular cylinder.

3. The apparatus for three-dimensional printing of claim 2, wherein the filament tube is parallel to the tilting axis.

4. The apparatus for three-dimensional printing of claim 1, wherein a center-axis of the elongated nozzle is perpendicular to the tilting axis; a tilting motion of the tilting print head enables the elongated nozzle upward and downward orientated printing.

5. The apparatus for three-dimensional printing of claim 4, wherein the elongated nozzle is provided to extend a distance between the tilting print head and the printing part to avoid collision.

6. The apparatus for three-dimensional printing of claim 1, wherein the gantry body comprises an X-column, a Y-column, a Z-column and a base frame, the X-column is perpendicular to the Y-column, the Y-column is perpendicular to the Z-column;
the carriage is slidably connected to the X-column; the X-column is slidably connected to the Y-column; the Y-column is slidably connected to the Z-column; the Z-column and the rotary table are fixed on the base frame;
a translational motion direction of the carriage along the X-column is horizontal; a translational motion direction of the Y-column along the Z-column is vertical.

7. The apparatus for three-dimensional printing of claim 1, further comprising:
a controller comprising processing circuitry configured to:
receive a position instruction, a build orientation instruction and an extrusion rate instruction;
control a motion of the gantry based on the position instruction;
control a motion of the tilting print head and a motion of the rotary table based on the build orientation instruction; and
control the tilting print head to dispense the printing material based on the extrusion rate instruction.

8. A method for three-dimensional printing, implemented by an apparatus for three-dimensional printing, the apparatus for three-dimensional printing comprises:
a gantry, comprising a gantry body and a carriage mounted on the gantry body; the carriage is movable along an X axis, a Y axis and a Z axis of the gantry;
a tilting print head mounted on the carriage, the tilting print head is configured to dispense printing material; the tilting print head is rotatable around a tilting axis; the tilting axis is parallel to the X axis; and
a rotary table configured to hold a printing part, the rotary table is rotatable around a rotation axis; the rotation axis is parallel to the Z axis;
the method comprising:
receiving a position instruction, a build orientation instruction and an extrusion rate instruction;
controlling a motion of the gantry based on the position instruction;
controlling a motion of the tilting print head and a motion of the rotary table based on the build orientation instruction; and
controlling the tilting print head to dispense the printing material based on the extrusion rate instruction.

9. The method for three-dimensional printing of claim 8, wherein the build orientation instruction includes a tilting angle of the tilting print head θ and a rotation angle of the rotary table φ;
a printing orientation n is represented as a unit vector n=[nₓ n_{y} n_{z}] which is located on a sphere with radius of 1; θ=cos⁻¹(n_{z}), and φ=tan⁻¹(n_{y}/nₓ).

10. The method for three-dimensional printing of claim 8, further comprising:
generating a printing model partitioned into different parts with different build directions;
the position instruction, the build orientation instruction and the extrusion rate instruction are generated based on the printing model.
